(19) United States
(12) Patent Application Publication
(10) Pub. No.: US 2009/0255938 A1
(43) Pub. Date: Oct. 15, 2009

(54) CRYOGENIC STORAGE CONTAINER

(76) Inventor: Tannin J. Fuja, Iowa City, IA (US)

Correspondence Address: MICHAEL RIES, 318 PARKER PLACE, OSWEGO, IL, 60543, US

(21) Appl. No.: 12/423,998

(22) Filed: Apr. 15, 2009

Related U.S. Application Data
(60) Provisional application No. 61/044,997, filed on Apr. 15, 2008.
(60) Provisional application No. 61/046,706, filed on Apr. 21, 2008.
(60) Provisional application No. 61/087,705, filed on Aug. 10, 2008.

(51) Int. Cl. F17C 1/00; B65D 25/00; B65D 41/04; F25B 19/00

(52) U.S. Cl. 220/560.05; 220/628; 220/288; 62/51.1

(57) ABSTRACT

A cryopreservation storage and processing container for cryogenic material is disclosed. In one embodiment, the container can be used to cryopreserve and store biological specimens at cryogenic temperature but also can be used directly in centrifuges or microcentrifuges to process biological materials. It incorporates the functions of both storage container and centrifuge tubes, provides self-sealing mechanism, and accommodates higher cooling/warming rates. The storage container includes both a vessel body 14 and a cap 12.

### RELATED APPLICATIONS

This application claims the benefit of U.S. Provisional Patent Application Ser. Nos. 61/044,997, filed 15 Apr. 2008. The following U.S. Provisional Patent Applications are incorporated by reference into this present non provisional application, 61/046,706, filed 21 Apr. 2008 and 61/087,705, filed 10 Aug. 2008.

### BACKGROUND OF THE INVENTION

Biology, biochemistry immunology, and biotechnology often rely on the cryopreserved biological specimens for research, clinical and therapeutic developments. In the typical laboratory practice, the biological specimen is frozen in a cryovial and stored in a cryogenic freezer or dewar for a period of time. At the point of usage, the pre-cryopreserved specimen stored in the cryovial is taken from the freezer or dewar, and thawed in a warm water bath. After thawing, the solution is removed by a pipette and put into a centrifuge tube. The tube is then placed in a rotor and centrifuged to separate solid particles, such as cells, suspended in the solution or supernatants. When the supernatant is withdrawn from the tube the particles may be removed for analysis or re-suspended for further processing.

Some limitations of this approach exist. For example, at least three different devices (e.g. a cryovial, a pipette, and a centrifuge tube) are typically required and multiple procedures are involved. Moreover, it is time consuming and materials are wasted because each device has to be disposed once used. This procedure also increases the potential risk of cross-contamination, particularly when processing several samples at the same time. Nonetheless, this approach is one of the most common procedures performed in research and clinical laboratories because the existing products are not ideal for both cryopreservation as well as centrifugation.

Furthermore, in the cryopreservation of biological materials, freezing injuries play an important role in the viability and survival rate of the cryopreserved specimens. Cooling and warming rates are two determinants of freezing injuries. It is commonly believed that the higher warming rate the less ice crystal formation during the thawing process, consequently the less freezing injuries and the higher viability. Since ice re-crystallization is more likely to occur during thawing stage, increasing the warming rate is extremely important. Cooling can be more complicated. In the region where vitrification, an ice-free solidification, cannot be achieved by the combination of cryoprotectants and the cooling rate, there exists an optimal cooling rate for each individual biological specimen. In the region where vitrification can be achieved, however, the necessary concentration of cryoprotectants is reported to be inversely proportional to the cooling rate. Increase of cooling rate by one order will reduce the required cryoprotectants by 1 M. Since cryoprotectants, especially at high concentration, are typically toxic and can cause osmotic injuries, vitrification achieved by high cooling rate and less concentration cryoprotectants will result in higher viability and survival rate.

One central objective of the present invention is to design a multifunctional vessel that can be used for the cryopreservation of biological specimens as well as in the centrifugation process. Other objectives include: (1) higher cooling and thawing rates, particularly higher thawing rate, to enhanced the viability of cryopreserved biological specimen, (2) a better sealing design to reduce the cross-contamination and potential explosion, (3) prevention of cap expelling or vessel shattering during centrifugation at high speed, (4) convenient extraction of the particles (such as cells), and (5) capability of standing upright.

### SUMMARY OF THE INVENTION

The present disclosure relates to one or more of the following features, elements or combinations thereof.

The present invention relates to a disposable storage container that not only can be used to cryopreserve and store biological specimens at cryogenic temperature but also can be used directly in centrifuges or microcentrifuges to process biological materials. It incorporates the functions of both storage container and centrifuge tubes. With the present invention, handling and processing of biological specimens can be simplified. Instead of using as many as three or more devices, only a single device is needed. Pipetting samples from storage container to centrifuge tubes is eliminated. Moreover, the inventive container is designed with a cap, which seals the specimen within the vessel body to prevent spillage or contamination during the cryopreservation and the centrifugation processes. The potential risk of cross-contamination is reduced to a minimum. Furthermore, the container disclosed herein can provide higher cooling rates and higher warming rates for cryopreservation, resulting in higher viability and survival rate of biospecimens during cryopreservation and processing. In addition, the present invention is capable of standing upright on a flat surface without a separate support, the feature lacking in typical centrifuge tubes.

Additional features of the disclosure will become apparent to those skilled in the art upon consideration of the following detailed description of preferred embodiments exemplifying the best mode of carrying out the invention as presently perceived.

### BRIEF DESCRIPTION OF THE DRAWINGS

FIG. 1 is a perspective view of a storage container according to the present invention; and

FIGS. 2A and 2B are cross-sectional views of the storage container of FIG. 1.

### DETAILED DESCRIPTION OF EMBODIMENTS OF THE INVENTION

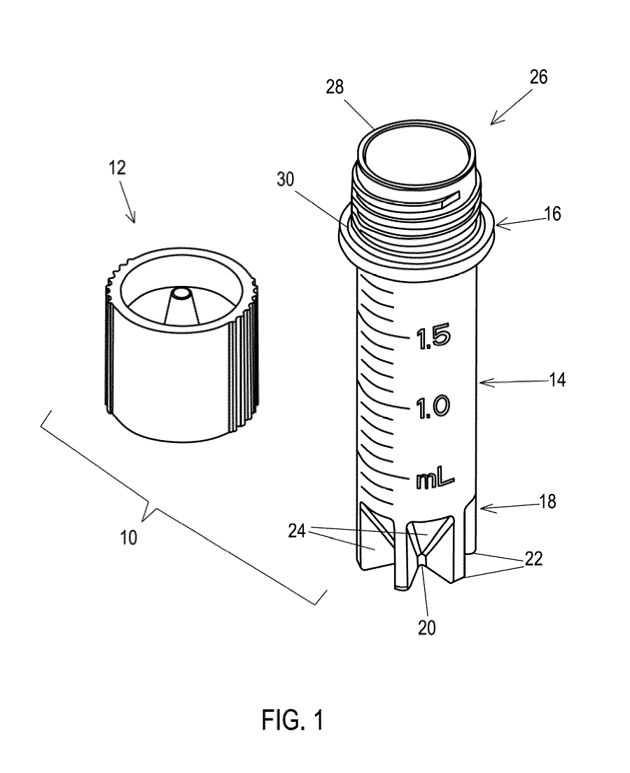

In one embodiment of the invention, shown in FIG. 1, a cryogenic storage container (10) includes a cap (12) and a vessel body (14). In the illustrated embodiment, a flange (16) is provided on vessel body (14) and a specialized bottom end (18) is formed in vessel body (14).

As shown in FIG. 1, the illustrated bottom end (18) is tapered so as to lead to a narrower tip (20). It is contemplated that tip (20) may be rounded or pointed. However, a plurality of fins (22) are positioned at bottom end (18) so as to provide, among other things, a stand that supports container (10) when it is positioned to stand on its bottom end (18) and better heat transfer capabilities during cooling and thawing steps in the cryopreservation process.

Between fins (22) at the bottom end (18) forms multiple vapor passages (24). Vapor passages (24) provide pathways to release vapor formed during cryopreservation. As such, it reduces vapor accumulation and vapor insulation layer at the bottom of the storage container 10, and thus facilities better heat transfer from cooling media to vessel body.

Beyond heat transfer assets, the disclosed container (10) serves additional functions. When it is desired to extract specimens from container (10) for analysis, container (10) can be placed directly on a rotor. During the centrifugation, flange (16) is placed on the top surface of the rotor, thereby supporting the suspension of vessel body (14). Centrifugal force, sometimes up to several thousand times that of gravity, exerts force on the flange. During this time, fins (22) illustratively provide structural integrity to vessel body (14) and make contact with the walls of the rotor. This construction provides further support to the vessel.

Flange (16) and fins (22) also provide support to keep cap (12) in place, making it less likely to be detached from vessel body (14), and less likely for vessel body to shatter during centrifugation. Furthermore, with the tapered shape of tip (20), particles that accumulate at the bottom of vessel body (14) after centrifugation are more easily extracted.

Mating end (26) of vessel body (14) illustratively has a tapered ring tip (28) and a tapered ring base (30) at the flange (16). In this embodiment, tapered ring tip (26) is designed to fit inside cap (12) whereas tapered ring base (30) is designed to fit the outside cap (12). These two tapered rings are illustratively configured to deform when fully engaged with cap (12), thereby providing a better seal against vessel body (14).

Due to the disclosed design features, the present invention can be used not only as a conventional storage container for cryopreservation, but also as a conventional centrifuge tube for centrifugation. By using the disclosed container (10), the typical laboratory practice for cryopreservation and centrifugation can be shortened to the following:

(1) the biological specimen is frozen in the present invention and stored in a cryogenic freezer or dewar for a period of time;

(2) when desired, the cryopreserved specimen stored in the present invention is taken out from the freezer or dewar and thawed in a warm water bath; and

(3) after thawing, the container is placed directly on a rotor and centrifuged to separate solid particles, such as cells, suspended in the solution or supernatants. When the supernatant is withdrawn from the tube the particles may be removed for analysis or re-suspended for further processing.

The presently disclosed container 10 achieves a higher cooling rate and higher warming rate in part due to the materials used in its construction and in part due to its design. Container 10 may be made of conventional materials, such as conventional plastics, preferably polypropylene. Container 10 may also be made of thermally conductive materials, such as thermally conductive plastics, quartz, glass, or metals, preferably thermally conductive polypropylene. Selected thermal conductive materials have thermal conductivity of 1 W/m-K or above. Existing vials or storage container are made of conventional plastics with thermal conductivity of approximately of 0.1 to 0.2 W/m-K. With high thermal conductivity, heat can be transferred through the wall of container 10 much more easily and quickly.

Container 10 will provide higher cooling rates and higher warming rates during the cooling and thawing processes in the cryopreservation of biological materials. Higher cooling rates can reduce the necessary concentration of cryoprotectants and consequently reduce the toxicity and osmotic injuries. During thawing, ice re-crystallization is more likely to occur. As such, higher warming rates reduce the freezing injuries and hence enhance cells' survival rate.

In addition to the choice of materials, container 10 has physical features that enhance the heat transfer: (a) the tapered tip 20 bottom end 18 of container 10, e.g. a conical shape, (b) fins 22, and (c) vapor path along the sides of the base 24, such as holes, slots, or any openings which can allow vapor to escape from the base. With the narrow sharp shapes, the heat transfer inside of the specimens can be enhanced. Heat can be easily and quickly transferred away directly through the thermally conductive materials. With vapor passages along the sides of the base, vapor can escape and hence will not accumulate and form an insulation layer around the base. As a result, heat transfer from the cooling/warming media to container 10 is enhanced.

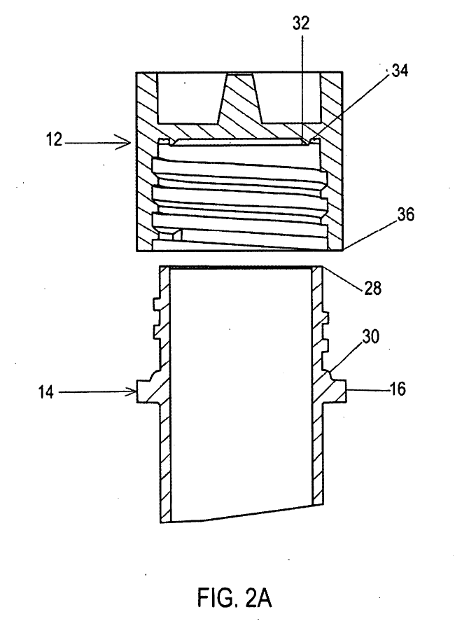

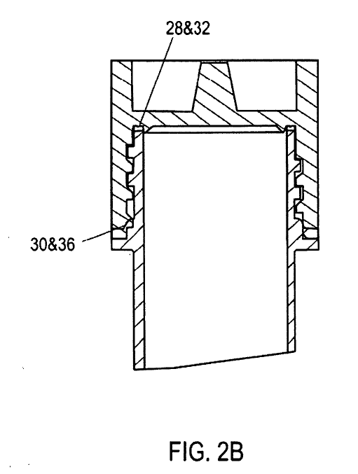

In the embodiment shown in FIGS. 2A and B, cap 12 is formed to self-seal with vessel body 14 and thereby prevent cross-contamination and explosion that sometimes occurs when a container is not properly sealed. Cap 12 illustratively has a ring 32 extending forward, a small sharp ring tip 34 along the ring 32 and a flat edge 36. When cap 12 and vessel body 14 are engaged and pushed forward, ring 32 mates with the ring tip 28 of the vessel body to form a tight fit. The sharp ring tip 34 cuts into the ring tip 28, and deformation occurs in both tips 28 and 34. This deformation seals the disclosed container 10. Furthermore, the flat edge 36 of cap 12 is pressed against the tapered ring base 30 at the flange 16. Deformation also occurs at this location and further seals the disclosed container 10. Similar deformation can be created by the pressure difference between the inside and outside of container 10 when container 10 is placed in a cryogenic environment. As the temperature of container 10 changes, whether empty or filled with biological materials, a partial vacuum is created inside container 10. Pressure differences between the outside and inside of container 10 push ring tip 34 and the edge 36 of the cap 12 forward, creating similar deformation in ring tips 28 and 34 and in tapered base 30 and flat edge 36. These deformations provide a stronger seal when container 10 is immersed in cryogen. In addition, a bar code can be printed on either the side or the top part of the cap.

The presently disclosed cap 12 and its design concept can be used with any container, preferably container 10, in cryopreservation, such as cryopreservation of cells, blood, and other biological materials, in the assisted reproduction (IVF), in livestock agribusiness, in rescue of endangered animal species, and in research and clinical uses.

The present invention can be manufactured easily, such as by injection molding. The cap and the vessel body can be made of the same material or of different materials. In one embodiment, the cap can be made of a material with the thermal expansion coefficient slightly different from that of the material for the vessel body. Depending on the design, the coefficient can be slightly higher or lower. As such, when placed into the cryogenic environment, the cap will shrink more or expand more (depending on the design) than the vessel body such that the cap will tighten the body and improve the seal. Furthermore, the vessel body can be made of thermally conductive materials, such as thermally conductive plastics, to further enhance the heat transfer during the cryopreservation process.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as defined by the appended claims.

A plurality of advantages arises from the various features of the present disclosure. It will be noted that alternative embodiments of various components of the disclosure may not include all of the features described yet still benefit from at least some of the advantages of such features. Those of ordinary skill in the art may readily devise their own implementations of a target marker buoy that incorporate one or more of the features of the present disclosure and fall within the spirit and scope of the disclosure.

What is claimed is:

1. A biological sample container for sample processing wherein processing utilizes one or more of cryogenic, storage and centrifugal methods, the container comprising:
a vessel body having a plurality of fins located at the tapered bottom of the vessel body on or near the rounded or pointed tip of the tapered bottom; and
a cap having a protrusion, wherein the cap is configured to mate with and seal the vessel body that is configured to provide support to keep the cap in place during centrifugation and make it less likely to become detached from the vessel body during centrifugation.

2. A biological sample container according to claim 1, wherein at least one flange and fins are configured to provide support and keep the cap in place during centrifugation, and the cap comprises an inside cap portion and an outside cap portion.

3. A biological sample container according to claim 2, wherein the mating end of the vessel body that mates with the container cap are configured to provide a vessel body having a tapered ring tip and a tapered ring base at the flange, wherein the tapered ring tip is designed to fit an inside cap portion and the tapered ring base is designed to fit an outside cap portion.

4. A biological sample container according to claim 2, wherein a plurality of fins provide structural integrity for the vessel body during centrifugation.

5. A biological sample container according to claim 3, wherein the cap and vessel form a self sealing mechanism during pressure difference occurring with cryopreservation processing.

6. A biological sample container according to claim 5, wherein the cap has a ring extending forward, a small ring tip along the ring and a flat edge for the cap to mate with a ring tip of the vessel body such that the cap engages the vessel as the cap and vessel are pushed forward to cause the sharp ring tip of the cap to mate with a ring tip of vessel and cut into the ring tip such that deformation occurs at the surface of both the cap and the vessel contact points to seal the container, and concurrently the flat edge of the cap is pressed against the tapered ring base of the container at the flange to provide additional deformation and further sealing of the container.

7. The container according to claim 6, wherein differences in pressure outside the vessel and inside the vessel create further deformations at mating points for the cap and vessel and providing additional sealing of the container.

8. The container according to claim 6, wherein both the vessel and cap are threaded to provide for engagement and mating of the cap and vessel.

9. The container according to claim 6, wherein the cap and the vessel—can be constructed with the same materials or constructed with different materials to have different coefficients of thermal expansion.

10. A biological sample container manufactured in such a say so as to improve the ability of the container to provide cryogenic biological sample processing, wherein processing comprises one or more steps of cryogenic freezing or thawing, cryogenic storage and thawed sample centrifugal methods, the container comprising:
a vessel body having a plurality of fins located at the tapered bottom of the vessel body on or near the rounded or pointed tip of the tapered bottom;
the vessel body further having a plurality of vapor passages along the sides of the base of the vessel that provide pathways to release vapor formed during cryopreservation or thawing; and
a cap having a protrusion, wherein the cap is configured to mate with and seal the vessel body that is configured to provide support to keep the cap in place during centrifugation and make it less likely to become detached from the vessel body during centrifugation,
wherein,
features at the bottom end of the vessel body permit the container to be able to stand alone when placed on a flat surface and also provide structural integrity during centrifugation, and
features along the interior of the vessel permit good heat transfer capabilities during cooling and thawing of the biological sample.

11. A biological sample container according to claim 10, wherein the container enhances heat transfer during cryogenic freezing or thawing process and the container comprises a tapered tip bottom end with a substantially narrow shape, fins, and a vapor path along the sides of the base of the vessel comprising one or more of holes, slots, grooves, cavities and openings.

12. A biological sample container according to claim 11, comprising a vessel base wherein the substantially narrow sharp shape is a conical shape.

13. A biological sample container according to claim 11, wherein the container comprises thin walls and the container may be comprised of a thermally conductive material or is comprised of a low conductive or non-conductive material.

14. A biological sample container according to claim 13, wherein the vessel body is constructed of a thermally conductive plastic, quartz, glass, metal, or a combination thereof.

15. A biological sample container according to claim 14, wherein the vessel body includes thermally conductive polypropylene.

16. A biological sample container according to claim 14, wherein the vessel body is constructed of materials having a thermal conductivity of at least 1 W/m-k.

17. A biological sample container according to claim 11, wherein at least one flange and fins are configured to provide support and keep the cap in place, and the cap comprises an inside cap portion and an outside cap portion.

18. A biological sample container according to claim 17, wherein the mating end of the vessel body that mates with the container cap are configured to provide a vessel body having a tapered ring tip and a tapered ring base at the flange, wherein the tapered ring tip is designed to fit an inside cap portion and the tapered ring base is designed to fit an outside cap portion, and wherein a plurality of fins provide structural integrity for the vessel body during centrifugation.

19. A biological sample container according to claim 18, wherein the cap and vessel form a self sealing mechanism during pressure difference occurring with cryopreservation processing, and wherein the cap has a ring extending forward, a small ring tip along the ring and a flat edge for the cap to mate with a ring tip of the vessel body such that the cap engages the vessel as the cap and vessel are pushed forward to cause the sharp ring tip of the cap to mate with a ring tip of vessel and cut into the ring tip such that deformation occurs at the surface of both the cap and the vessel contact points to seal the container, and concurrently the flat edge of the cap is pressed against the tapered ring base of the container at the flange to provide additional deformation and further sealing of the container.

20. The container according to claim 19, wherein differences in pressure outside the vessel and inside the vessel create further deformations at mating points for the cap and vessel and providing additional sealing of the container, and both the vessel and cap are threaded to provide for engagement and mating of the cap and vessel.
